(19) United States
(12) Patent Application Publication
(10) Pub. No.: US 2012/0167691 A1
(43) Pub. Date: Jul. 5, 2012

(54) METHOD FOR RECORDING AND REPRODUCING PRESSURE WAVES COMPRISING DIRECT QUANTIFICATION

(75) Inventors: Albert Gilg, Kaufering (DE); Utz Wever, Munchen (DE)

(73) Assignee: SIEMENS AKTIENGESELLSCHAFT, München (DE)

(21) Appl. No.: 13/383,162

(22) PCT Filed: May 11, 2010
(86) PCT No.: PCT/EP2010/056476

§ 371 Date: Jan. 9, 2012

(30) Foreign Application Priority Data
Jul. 7, 2009 (DE) 10 2009 032 057.1

(51) Int. Cl. G01H 5/00

(52) U.S. Cl. 73/645

(57) ABSTRACT

In a method for recording and reproducing pressure wave signals, a wave pressure recording and an analog digital converter are to be linked. Higher dynamics are to be effected at identical bit depths and lower bit depths are to be required for identical dynamics. All information provided by the pressure wave signal is calculated and stored on the basis of detected and directly quantified wave pressure differences of the pressure wave signal. In addition, coefficients can be stored and, if necessary, retransformed into absolute wave pressures. In this way, the pressure wave signal can be reproduced.

### CROSS-REFERENCE TO RELATED APPLICATIONS

This application is a U.S. National Stage Application of International Application No. PCT/EP2010/056476 filed Mar. 11, 2010, which designates the United States of America, and claims priority to German Patent Application No. 10 2009 032 057.1 filed Jul. 9, 2009. The contents of which are hereby incorporated by reference in their entirety.

### TECHNICAL FIELD

The present invention relates to a method for recording pressure wave signals, a method for reproducing said pressure wave signals and corresponding pressure-gradient microphones for recording pressure wave signals, as well as corresponding uses.

The present invention concerns, in particular, the recording of pressure wave signals.

### BACKGROUND

Conventionally, a sound pressure is measured using a sound pressure microphone which detects absolute wave pressures. An analog audio signal is produced and the sizes of amplitudes of current oscillations are subsequently quantified by means of an analog/digital converter. Following creation of an analog audio signal, analog/digital conversion for storage takes place on, for example, a conventional compact disk (CD). According to a conventional method, analog recording of a signal is performed with a microphone. This can possibly be followed by compression and storage. Compression can be accomplished with, for example, a conventional MP3 method.

According to Nyquist, for analog/digital conversion of an analog audio signal, at least twice the frequency of the highest frequency to be resolved is used as the sampling rate, wherein a bit rate to be processed is a product of the sampling rate, a bit depth determining a number of bits to be used and the number of channels used.

For example, for a music CD, frequencies in the range from 20 Hertz to 20 kilohertz are recorded. In the ultrasonic region, frequencies in the range from 20 KHz to 1 GHz are recorded. In the case of an audio CD, for analog/digital conversion, a sampling rate of 44.1 KHz is used. Furthermore, 16 bits are conventionally used for resolving the dynamics between the quietest and the loudest sounds. If two channels are used, a bit rate of 44.1 KHz*2 channels*16 bit=1.411 Mbps is to be processed.

### SUMMARY

According to various embodiments, a recording of pressure wave signals can be provided, particularly sound wave signals such that a wave pressure recording and an analog/digital conversion can be brought together. It is intended that the reproduction of pressure wave signals should be made particularly easy. Suitable pressure-gradient microphones are also to be provided. A greater dynamic range is to be achieved with the same bit depth and, given the same dynamic range, a smaller bit depth is to be required. The dynamic range is the distance between the weakest and strongest pressure wave signals.

According to an embodiment, in a method for recording a pressure wave signal, directly quantified wave pressure differences of the pressure wave signal can be detected and stored.

According to a further embodiment, coefficients of a basis function containing information of the pressure wave signal can be calculated on the basis of the detected and directly quantified wave pressure differences of the pressure wave signal and stored. According to a further embodiment, the basis function can be a wavelet basis function. According to a further embodiment, respective different wave pressure differences from different measurement time intervals can be detected in repeating overall time intervals by a variety of pressure-gradient microphones. According to a further embodiment, an overall interval can be equally subdivided into a number of equal-length basic time intervals and the length of a basic time interval is determined by means of a highest and a lowest frequency to be resolved. According to a further embodiment, the highest frequency to be resolved can be divided by the lowest frequency to be resolved and the quotient determines the number and length of the basic time intervals in an overall time interval. According to a further embodiment, the number of basic time intervals can be expressed as a power of 2, that is 2^{m}, with the exponent m, which determines the number of pressure-gradient microphones used. According to a further embodiment, by means of a sound pressure microphone, absolute wave levels at all measurement time points of an overall time interval can be added to form a sum S. According to a further embodiment, all the coefficients can be calculated by means of the wave pressure differences detected and the sum S per overall time interval is calculated. According to a further embodiment, the wavelet basis function can be a Haar wavelet function, a Coiflet wavelet function, a Gabor wavelet function, a Daubechies wavelet function, a Johnston-Barnard wavelet function or a bioorthogonal spline wavelet function. According to a further embodiment, the wavelet basis function can be a Haar wavelet basis function, wherein in each instance, one of m pressure-gradient microphones detects pressure differences from 2ⁿ basic time intervals as the measurement time interval, the measurement time intervals each being separated from one another by 2ⁿ basic time intervals, wherein n is the element N₀ and n≦m−1. According to a further embodiment, compression can be carried out in that coefficients below a threshold value are ignored. According to a further embodiment, a plurality of different pressure-gradient microphones can be used for different frequency ranges. According to a further embodiment, the areas of detection diaphragms of the pressure-gradient microphones can be tuned to the respective frequency range. According to a further embodiment, the detection diaphragms of the pressure-gradient microphones can be arranged adjacent to one another in one housing. According to a further embodiment, the detection diaphragms can be arranged concentrically with one another. According to a further embodiment, detection diaphragms for higher frequency wave pressure differences can be arranged inwardly and detection diaphragms for lower frequency wave pressure differences are arranged outwardly.

According to another embodiment, in a method for reproducing a pressure wave signal recorded with a method as described above, by means of an upper Hessenberg matrix, the absolute wave pressures are calculated back from the stored pressure differences at all the measurement time points per overall time interval, and are output.

According to yet another embodiment, in a method for reproducing a pressure wave signal recorded with a method as described above, by means of an inverse transformation from the coefficients, optionally together with the sum S, the absolute wave pressures are calculated in reverse and reproduced for all the measurement time points per overall time interval.

According to yet another embodiment, in a pressure-gradient microphones for recording a pressure wave signal with a method as described above, areas of detection diaphragms of the pressure-gradient microphones are tuned to the respective frequency range.

According to a further embodiment of the microphone, the detection diaphragms of the pressure-gradient microphones can be arranged adjacent to one another in one housing. According to a further embodiment of the microphone, the detection diaphragms are arranged concentrically with one another. According to a further embodiment of the microphone, detection diaphragms for higher frequency wave pressure differences can be arranged inwardly and detection diaphragms for lower frequency wave pressure differences are arranged outwardly.

According to various other embodiments, a method or microphones as described above can be used for sound pressure waves in the audio range or the ultrasonic range in medicine or materials science or for seismic waves in geophysics or materials science.

### BRIEF DESCRIPTION OF THE DRAWINGS

The invention will now be described in greater detail by reference to exemplary embodiments, in conjunction with the drawings, in which:

FIG. 1a-d is an illustration of a data flow of a conventional recording procedure;

FIG. 2a-c are examples of conventional sound pressure microphones;

FIG. 3 is an illustration of measurements from a conventional recording method;

FIG. 4a-c is an illustration of two exemplary embodiments of pressure-gradient microphones and a measuring principle;

FIG. 5a-d is an illustration of the required pressure measurements of wave pressure differences for calculating the coefficients of a basis function;

FIG. 6a is the shape of a Haar wavelet basis function;

FIG. 6b is an illustration of the principle according to various embodiments;

FIG. 7 is, once again, the measurement time intervals I_{M} of individual microphones;

FIG. 8 is an exemplary embodiment of detection diaphragms of pressure-gradient microphones;

FIG. 9 is an inverse transformation of coefficients into absolute sound wave pressures.

### DETAILED DESCRIPTION

According to a first aspect, a method is provided for recording a pressure wave signal such that information from the pressure wave signal is detected by means of detected and directly quantified wave pressure differences of the pressure wave signal. According to a method for recording a pressure wave signal, wave pressure difference values can be stored. A pressure wave signal is, for example, a music signal, an ultrasonic signal or a seismic wave.

According to various embodiments, a recording method is provided which combines wave pressure recording and analog/digital conversion. The recording of wave pressure differences brings numerous advantages. Wave pressure differences are measured and directly quantified.

According to a second aspect, a method for reproducing a pressure wave signal recorded with a method according to various embodiments is provided in that, by means of an inverse transformation from the pressure wave difference values or the coefficients, optionally together with a sum S, the absolute wave pressures are calculated in reverse for all the measurement time points per overall time interval. Following the calculation, reproduction, for example, by means of a loudspeaker can be carried out.

According to a third aspect, pressure-gradient microphones are provided for recording a pressure wave signal with a method according to various embodiments such that areas of detection diaphragms of the pressure-gradient microphone are tuned to the respective frequency range. This means that the greater is the respective frequency of the frequency range, the smaller is the area of a detection diaphragm of a pressure-gradient microphone.

According to a fourth aspect, various methods or microphones for sound pressure waves can be used in the audio range or the ultrasonic range, in medicine or materials science or for seismic waves in geophysics or in materials science.

The advantages according to various embodiments are:

A greater dynamic range for the same bit rate. Usually the differences are very similar. The result is that the distribution over the same bit depth produces a greater dynamic range. The same dynamic range is also given by a lower bit rate. The small variations between the differences means that in the quantification, a smaller bit depth and thus a smaller bit rate is sufficient. Possibilities for adaptation. A constant bit rate is selected for a sound pressure recording, so that a smaller bit depth can be used for quantifying the differences and a greater bit depth can be used for the absolute summation.

Wavelet coefficients must also be digitized for storage. The various embodiments enable a conflation of recording and analog/digital conversion. A wave pressure difference measurement is carried out with pressure gradient microphones.

According to an embodiment, a method for recording a pressure wave signal can be provided in that coefficients of a basis function containing information of the pressure wave signal are calculated on the basis of detected and directly quantified wave pressure differences of the pressure wave signal. According to a method for recording a pressure wave signal, according to various embodiments, coefficients of a basic function can be stored following the calculation.

According to an embodiment, the base function can be a wavelet base function. Conventionally, a low-pass filter is needed for analog/digital conversion in order to prevent frequencies higher than half the sampling rate from occurring. This is known as aliasing. Using a wavelet-based recording, higher frequencies can be directly excluded.

According to a further embodiment, respective different wave pressure differences from different measurement time intervals can be detected in repeating overall time intervals by a variety of pressure-gradient microphones. At the same time, wave pressure differences are measured for different time intervals.

According to a further embodiment, an overall interval can be equally subdivided into a number of equal-length basic time intervals and the length of a basic time interval can be determined by means of a highest and a lowest frequency to be resolved. An overall time interval is a smallest unit for which the coefficients of a basis function are calculated. According to a method for recording a pressure wave signal, the pressure wave signal is sampled over a plurality of repeating overall time intervals.

According to a further embodiment, the highest frequency to be resolved can be divided by the lowest frequency to be resolved and the quotient can determine the number and length of the basic time intervals in an overall time interval. In order to detect the wave pressure differences of the pressure wave signal, a maximum sampling rate can be determined dependent on the highest frequency to be resolved and a minimum sampling rate can be determined dependent on the lowest frequency to be resolved, in each case, according to Nyquist, the maximum sampling rate can be divided by the minimum sampling rate and the quotient can determine the number and length of the basic time intervals in the repeating overall time interval. A measurement time interval is determined by a number of basic time intervals. Measurement time intervals are spaced apart from one another by a number of basic time intervals.

According to a further embodiment, the number of basic time intervals can be expressed as a power of 2, that is 2^{m}, with the exponent m, which determines the number of pressure-gradient microphones used.

According to a further embodiment, by means of a sound pressure microphone, absolute wave levels at all measurement time points of each overall time interval can be added to form a sum S. A measurement is made following each basic time interval. Each of the measurement time points can be determined by the end of a basic time interval. The sum S is merely an expression of a calibration and is only used if a plurality of overall intervals is recorded.

According to a further embodiment, all the coefficients can be calculated by means of the wave pressure differences detected and the sum S per overall time interval can be calculated.

According to a further embodiment, the wavelet basis function can be a Haar wavelet function, a Coiflet wavelet function, a Gabor wavelet function, a Daubechies wavelet function, a Johnston-Barnard wavelet function or a bioorthogonal spline wavelet function.

According to a further embodiment, in the case of a Haar wavelet function, in each instance, one of m pressure-gradient microphones can detect pressure differences of 2ⁿ basic time intervals as the measurement time interval, the measurement time intervals each being separated from one another by 2ⁿ basic time intervals, wherein n is the element N₀ and n≦m−1.

According to a further embodiment, the storage can be compressed in that the wavelet coefficients that are calculated from the pressure differences are ignored below a threshold value. Wavelet coefficients below a threshold value do not contribute anything to the signal.

According to a further embodiment, a plurality of different pressure-gradient microphones can be used for different frequency ranges. That means that for the measurement of high-frequency differences, different pressure-gradient microphones can be used than for low frequency differences.

According to a further embodiment, the areas of detection diaphragms of the pressure-gradient microphones can be tuned to the respective frequency range. The higher the respective frequencies, the smaller are the surface areas of the detection diaphragms.

According to a further embodiment, the detection diaphragms of the pressure-gradient microphones can be arranged adjacent to one another in one housing. It is particularly advantageous if the detection diaphragms are accommodated spatially close to one another in one housing. The pressure difference measurements must belong to the same sound source.

According to a further embodiment, the detection diaphragms can be arranged concentrically with one another.

According to a further embodiment, in a concentric arrangement, detection diaphragms for higher frequency wave pressure differences are arranged inwardly and detection diaphragms for lower frequency wave pressure differences are arranged outwardly.

In a method for reproducing a pressure wave signal recorded with a method according to various embodiments, reproduction can be carried out by means of a loudspeaker.

According to a further embodiment, the inverse transformation can be carried out from the coefficients to absolute wave pressures by means of an upper Hessenberg matrix.

According to a further embodiment, pressure-gradient microphones can be provided such that areas of the detection diaphragms of the pressure-gradient microphones are each tuned to the relevant frequency range.

According to a further embodiment, the detection diaphragms of the pressure-gradient microphones can be arranged adjacent to one another in one housing.

According to a further embodiment, pressure-gradient microphones with detection diaphragms arranged concentrically with one another can be provided.

According to a further embodiment, detection diaphragms for higher frequency wave pressure differences can be arranged inwardly and detection diaphragms for lower frequency wave pressure differences can be arranged outwardly.

A method according to various embodiments can be used for the recording of music, ultrasound in medicine and materials science or seismology in geophysics and in materials science.

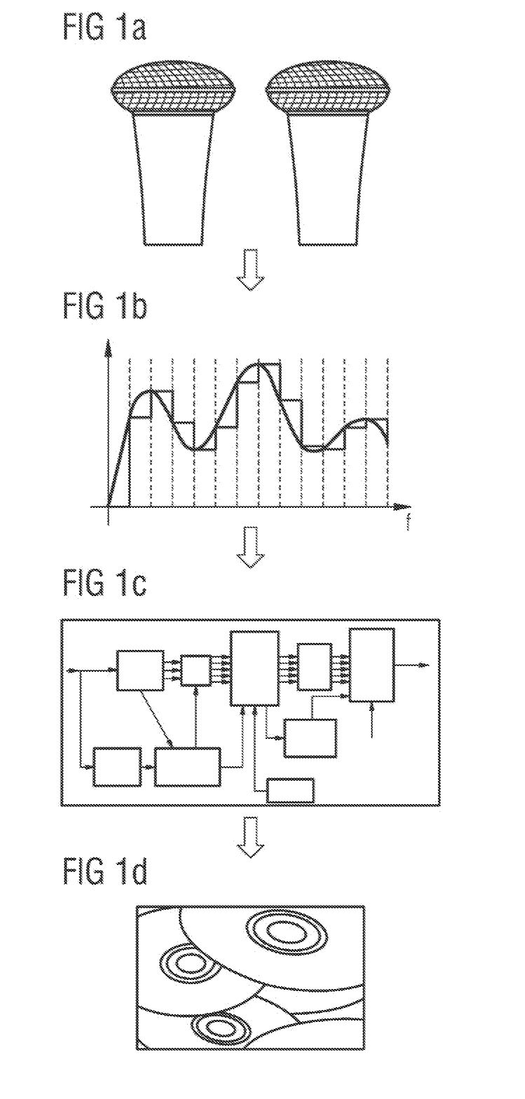

FIGS. 1a-d show a data flow of a conventional recording method. FIG. 1a shows sound pressure microphones for analog recording of an audio signal. FIG. 1b shows the variation over time of an analog signal recorded with a conventional sound pressure microphone and an associated sampling signal. FIG. 1c shows possible subsequent compression of the recorded signal, for example, using the conventional MP3 method. The data can subsequently be stored on a conventional CD (compact disk) as indicated in FIG. 1d.

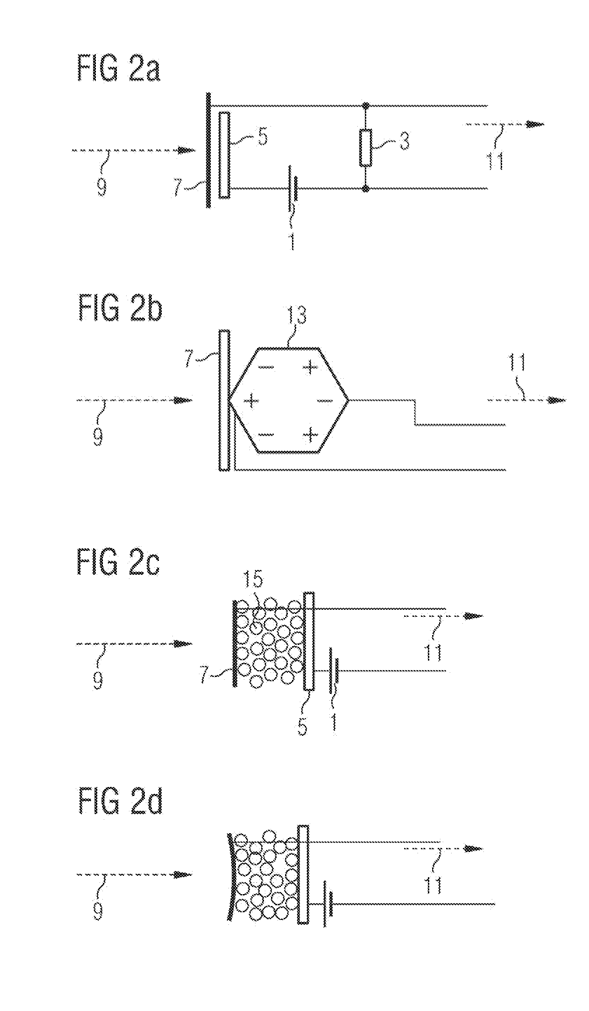

FIGS. 2a-c show examples of conventional sound pressure microphones. FIG. 2a shows the functional method of a conventional condenser microphone. A sound pressure influences the electrical capacitance. FIG. 2a shows a voltage supply 1, a high impedance resistor 3, a counter-electrode 5 and a diaphragm 7. Sound waves 9 are suitably converted into an electrical signal 11.

FIG. 2b shows a conventional piezoelectric microphone. A sound pressure influences the form of a piezoelectric element 13 and generates a voltage. Reference sign 7 refers to a diaphragm. Reference sign 9 indicates pressure waves or sound waves to be detected, which are converted into an electrical signal 11.

FIG. 2c shows the function of a conventional carbon microphone. A sound pressure influences the electrical resistance. Reference sign 1 denotes a voltage supply, reference sign 5 denotes a counter-electrode, reference sign 7 a membrane and reference sign 15 carbon granules. A sound wave signal 9 is converted by means of the carbon granules 15 into an electrical signal 11.

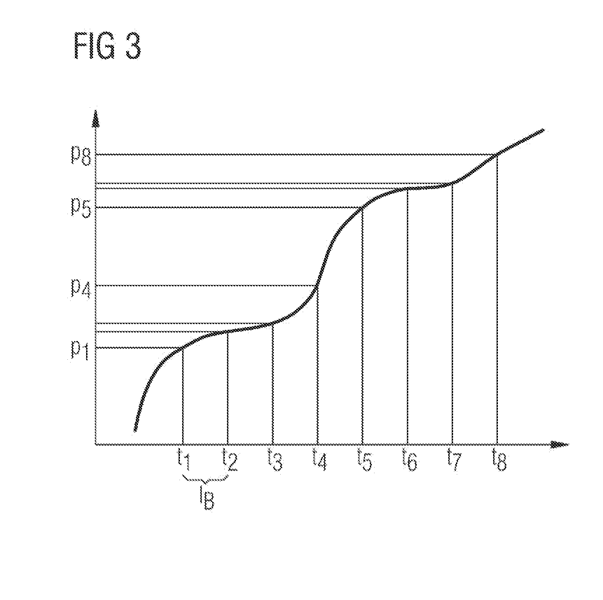

FIG. 3 shows measurements of a conventional recording method. Measurements are carried out at equal basic time intervals I_{B}. Recording is carried out with analog/digital conversion. The recording is made here with conventional sound pressure microphones. A sampling rate according to Nyquist is selected. The measurement time points t₁, t₂, . . . are set accordingly. In a subsequent step, the discrete sound pressures p₁, p₂, . . . are quantified with a pre-determined bit depth. In a further step, compression of the recording can be performed. An example of a compression method is the MP3 process. Thereafter, storage of the recording can take place. A precondition for storage and compression of the audio signal is that the decoder has real-time capability.

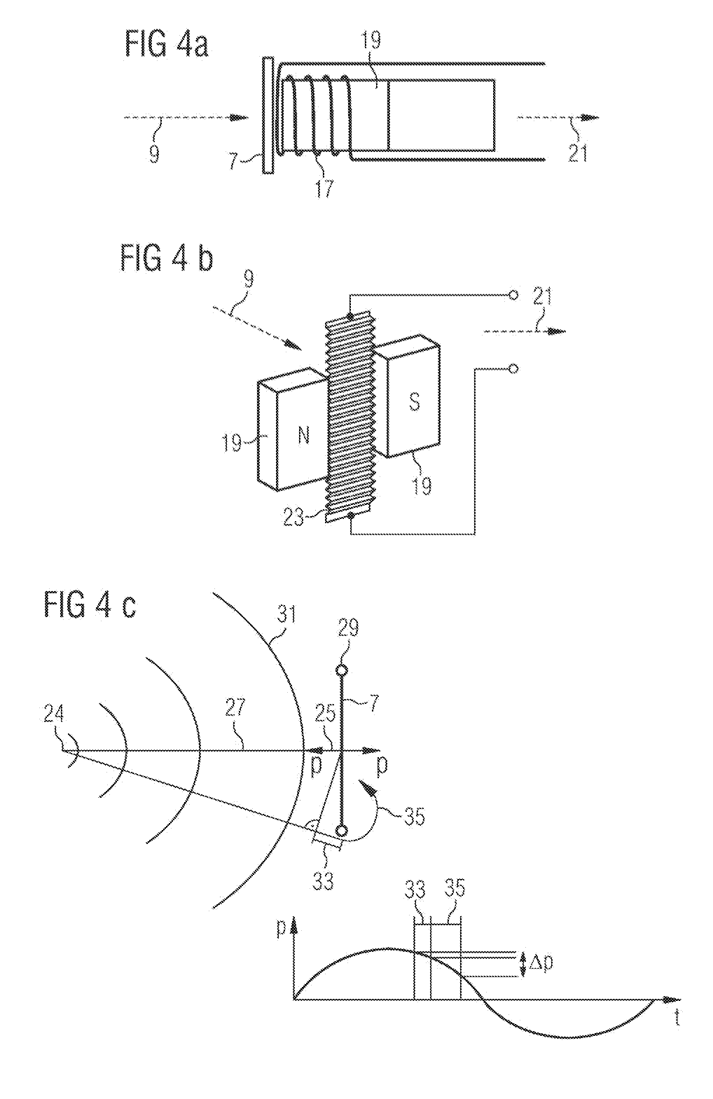

FIGS. 4a-c show two exemplary embodiments of pressure-gradient microphones and details of their mode of operation. FIG. 4a shows a coil 17 and a permanent magnet 19. A diaphragm 7 is also provided. Using the pressure-gradient microphone, sound waves 9 are converted into an electrical signal 21. A change in the sound pressure or a wave pressure induces a current in the coil 17.

FIG. 4b also shows a permanent magnet 19 between the north and south poles of which a folded aluminum band 23 is provided. In this case, also, changes in the wave signal pressure induces a current through the folded aluminum band 23. In this way, sound waves 9 are converted into an electrical signal 21.

FIG. 4c shows the conversion of a pressure wave signal into a deflection 25 of a diaphragm 7. Reference sign 24 denotes a source of a pressure wave. Reference sign 27 denotes the direct wave path from the source 24 to the membrane 7. Reference sign 29 denotes an elastic suspension of the membrane 7. Reference sign 31 denotes an incident wavefront. Reference sign 33 denotes a proximity effect and reference sign 35 denotes a sound detour.

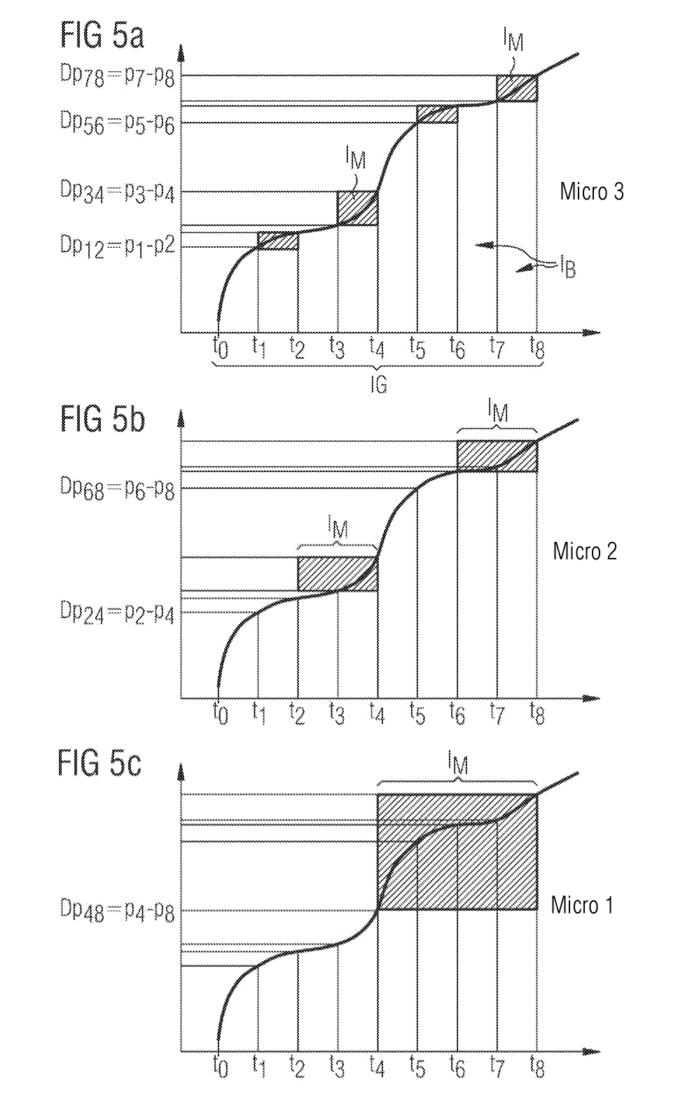

FIGS. 5a-d show the required pressure measurements of wave pressure differences for calculating the coefficients of a basis function. According to FIGS. 5a-5d, the basis function is a wavelet basis function, specifically a Haar wavelet function. All the information in the wavelet coefficient containing the pressure wave signal is calculated and, particularly, stored by means of detected and directly quantified wave pressure differences in the pressure wave signal.

According to FIG. 5a, an overall interval I_{G} is shown. An overall time interval I_{G} is divided into 8 equal-sized basic time intervals I_{B}. An overall pressure wave signal is detected by means a sequence of repeating overall time intervals I_{G}. Thus the overall time interval I_{G} shown in FIGS. 5a-5d is a smallest unit for detecting a pressure wave signal. According to FIGS. 5a-5c, using a variety of pressure-gradient microphones, different wave pressure differences for different measurement time intervals I_{M} are detected at repeating overall time intervals I_{G}. An overall time interval I_{G} is divided equally into a number of equal-length basic time intervals I_{B}. The length of a basic time interval I_{B} is determined by a maximum and a minimum frequency to be resolved. If the maximum frequency to be resolved is divided by the minimum frequency to be resolved, the quotient determines the number and length of the basic time intervals I_{B} in an overall time interval I_{G}. The number of basic time intervals I_{B} can be expressed as a power of 2, with the exponent m, i.e. 2^{m}, which determines the number of pressure-gradient microphones used. According to FIGS. 5a-5c, the number of basic time intervals is 8=2³, so that 3 pressure-gradient microphones will be used. FIG. 5a shows the measurement time intervals I_{M} of a microphone 3. FIG. 5b shows the measurement time intervals I_{M} of a microphone 2 and FIG. 5c shows the measurement time interval I_{M} of a microphone 1. Similarly, according to FIG. 5a, the pressure differences p₁-p₂, p₃-p₄, p₅-p₆ and p₇-p₈ are detected. According to FIG. 5b, the wave pressure differences of the pressure wave signal p₂-p₄ and p₆-p₈ are detected using measuring technology. According to FIG. 5c, the wave pressure difference p₄-p₈ is detected. According to FIGS. 5a-c, for the Haar wavelet basis function, for repeating overall time intervals I_{G}, the separation of adjacent measurement time intervals I_{M} is equal to the respective duration of a measurement time interval I_{M}.

FIG. 5d also shows the shape of the pressure wave signal to be measured in one overall time interval I_{G}. 8 measurement time points t₁, t₂ . . . t₈ are produced. Using a sound pressure microphone, absolute wave pressure levels at all the measurement time points (t₁ . . . t₈) of an overall time interval I_{G} are added together to a sum S in each case. This means that, according to FIG. 5d, a further microphone 0 is used, which is a sound pressure microphone in contrast to the pressure-gradient microphones 1 to 3. According to FIG. 5d, a sum S=p₁+p₂+p₃+p₄+p₅+p₆+p₇+p₈ is detected using the measuring technology. This sum serves to calibrate two successive overall time intervals. Other calibrations are also conceivable. If only one overall time interval is recorded, no calibration is needed. The differences are then sufficient. This sum is only an expression of the calibration and is only used if a plurality of overall time intervals is recorded.

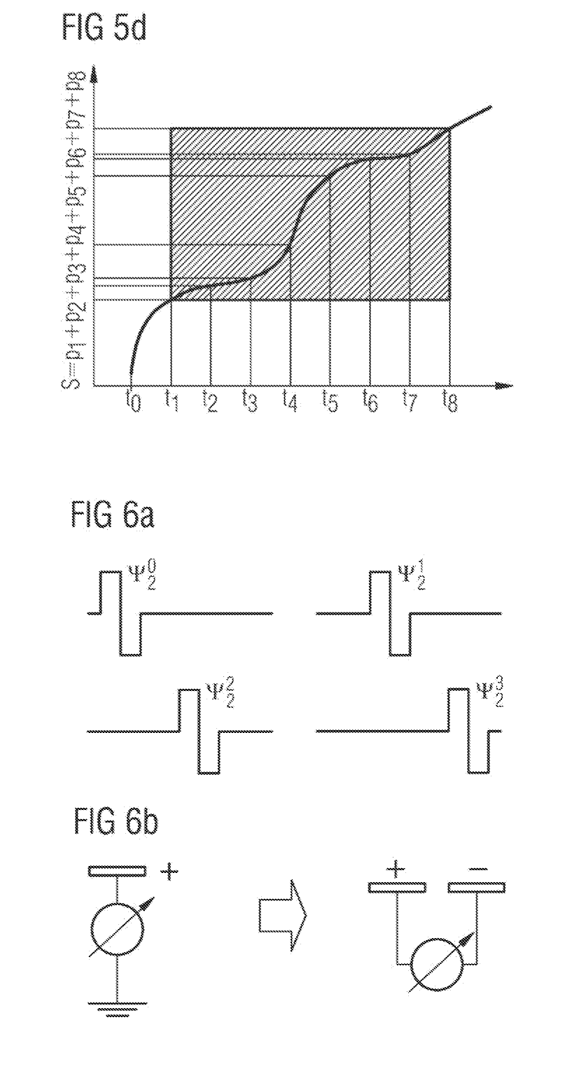

FIG. 6a shows the course of a Haar wavelet basis function. The Haar wavelet basis function is defined as:

$$ψ ( x ) = \{ \begin{matrix}1 & for 0 \leq x < \frac{1}{2} \\ - 1 & for ( \frac{1}{2} \leq x < 1 ) \\ 0 & otherwise\end{matrix}$$

Functions can be represented as a wavelet series:

$$f ( x ) = {\sum }_{j = 1}^{n} {\sum }_{i = 0}^{{2}^{j} - 1} {α}_{ij} ψ ( {2}^{- j} x + i )$$

According to a wavelet sensor, each signal can be resolved as the sum of differences. According to various embodiments, in place of the conventional absolute values, wave pressure differences are measured directly. This difference is illustrated by FIG. 6b.

FIG. 6a shows the course of a Haar wavelet basis function, which is taken as the basis for the measurement according to FIGS. 5a-5c.

FIG. 6b shows the principle that, in contrast to the prior art, no absolute wave levels are detected, but rather, in particular, directly quantified wave pressure differences.

The wavelet coefficients can be calculated directly using the measurements from the 4 microphones as per FIGS. 5a-5d.

It will now be described how, according to the detected wave pressure differences, as per FIGS. 5a-c, the sum, according to FIG. 5d, of all the wavelet coefficients can be calculated:

$${d}_{8} = \frac{1}{\sqrt{2}} ( {p}_{7} - {p}_{8} ) = \frac{1}{\sqrt{2}} {Dp}_{78}$$

$${d}_{7} = \frac{1}{\sqrt{2}} ( {p}_{5} - {p}_{6} ) = \frac{1}{\sqrt{2}} {Dp}_{56}$$

$${d}_{6} = \frac{1}{\sqrt{2}} ( {p}_{3} - {p}_{4} ) = \frac{1}{\sqrt{2}} {Dp}_{43}$$

$${d}_{5} = \frac{1}{\sqrt{2}} ( {p}_{1} - {p}_{2} ) = \frac{1}{\sqrt{2}} {Dp}_{12}$$

$${d}_{4} = \frac{1}{2} ( {p}_{5} + {p}_{6} - {p}_{7} - {p}_{8} ) = \frac{1}{2} ( {Dp}_{56} - {Dp}_{78} + 2 ( {p}_{6} - {p}_{8} ) ) = \frac{1}{2} ( {Dp}_{56} - {Dp}_{78} + 2 {Dp}_{68} )$$

$${d}_{3} = \frac{1}{2} ( {p}_{1} + {p}_{2} - {p}_{3} - {p}_{4} ) = \frac{1}{2} ( {Dp}_{12} - {Dp}_{34} + 2 ( {p}_{2} - {p}_{4} ) ) = \frac{1}{2} ( {Dp}_{12} - {Dp}_{34} + 2 {Dp}_{24} )$$

$$\begin{matrix}{d}_{2} = \frac{1}{2 \sqrt{2}} ( {p}_{1} + {p}_{2} + {p}_{3} + {p}_{4} - {p}_{5} - {p}_{6} - {p}_{7} - {p}_{8} ) \\ = \frac{1}{2 \sqrt{2}} ( {Dp}_{12} + {Dp}_{34} + 2 {p}_{2} + 2 {p}_{4} - {Dp}_{56} - {Dp}_{78} - 2 {p}_{6} - 2 {p}_{8} ) \\ = \frac{1}{2 \sqrt{2}} ( {Dp}_{12} + {Dp}_{34} + 2 {Dp}_{24} + 4 {p}_{4} - {Dp}_{56} - {Dp}_{78} - 2 {Dp}_{68} - 4 {p}_{8} ) \\ = \frac{1}{2 \sqrt{2}} ( {Dp}_{12} + {Dp}_{34} + 2 {Dp}_{24} - {Dp}_{56} - {Dp}_{78} - 2 {Dp}_{68} + 4 {Dp}_{48} )\end{matrix}$$

$$S = \frac{1}{2 \sqrt{2}} ( {p}_{1} + {p}_{2} + {p}_{3} + {p}_{4} + {p}_{5} + {p}_{6} + {p}_{7} + {p}_{8} )$$

The wavelet coefficients calculated contain all the information from the pressure wave signal in the overall time interval I_{G}. The calculated coefficients of a basis function which, in this case, is a Haar wavelet function, can be stored.

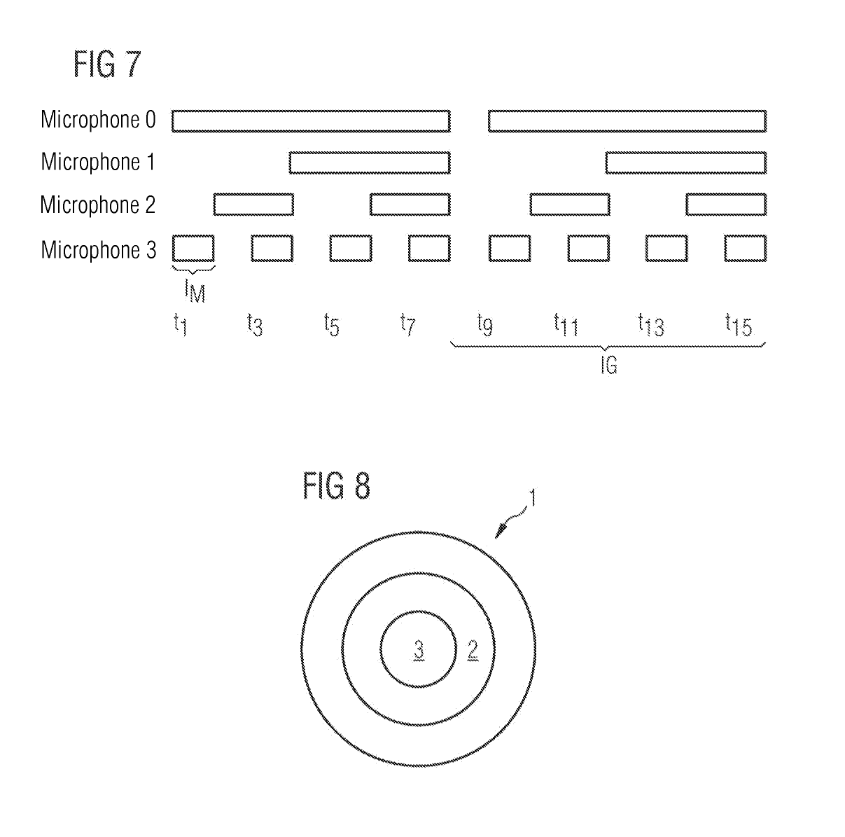

FIG. 7 shows, once again, the measurement time intervals I_{M} of the individual microphones 1, 2, 3 and 0. Microphone 0 is the sound pressure microphone for detecting the absolute wave level at all the measurement time points t₁ . . . t₁₆. FIG. 7 represents two successive overall time intervals I_{G}. Microphone 3 records high-frequency pressure differences. Microphone 2 records middle-frequency pressure differences. Microphone 1 records low-frequency pressure differences. Microphone 0 adds the absolute levels of the pressure wave signal.

Microphones 1, 2 and 3 of FIGS. 5 to 7 each have diaphragms which can be accommodated in one housing. Each diaphragm can be tuned to the frequency to be measured. For this purpose, a diaphragm of the microphone 3 is smaller than the area of a diaphragm of microphone 1. The recording membranes for the individual difference measurements are advantageously arranged very close to one another. In this way, the difference measurements can be assigned to the same pressure wave source. An embodiment that is particularly advantageous is shown in FIG. 8. According to FIG. 8, the detection diaphragms are arranged concentrically with one another. Inwardly arranged are the diaphragms for high-frequency differences and arranged outwardly is the diaphragm for the low-frequency differences. The diaphragm of microphone 3 is therefore arranged inwardly. Arranged therearound is the diaphragm of microphone 2. Arranged round the diaphragm of microphone 2 is the diaphragm of microphone 1.

A method according to FIGS. 5-7 has been described for the Haar wavelet. The method described can be extended to all the conventional wavelets. Furthermore, a method according to various embodiments can also be used for stereo recording. This involves addition and subtraction of the channels. The various embodiments are not restricted to the recording of music. The various embodiments can be used, in general, for all audio recordings, recordings in the ultrasonic range and, for example, also the detection of pressure waves in seismology or materials science. Essentially any pressure wave signals can be detected and stored.

A further exemplary embodiment of the method is the recording of audio signals onto a conventional compact disk. For this, a frequency range from 20 Hz to 20 kHz is to be resolved. According to Nyquist a maximum sampling frequency of 44.1 KHz is required for this. A theoretical minimum sampling frequency is 43 Hz. If the maximum sampling frequency is divided by a theoretical minimum sampling frequency, the result is a factor of 44.1 KHz/43 Hz=1024. This results in a number of 1024 basic time intervals I_{B}. 1024=2¹⁰. Therefore, in order to measure sound pressure differences, 10 pressure-gradient microphones are used. In addition, a sound pressure microphone is needed which adds the pressure levels over 1024 basic time intervals I_{B}.

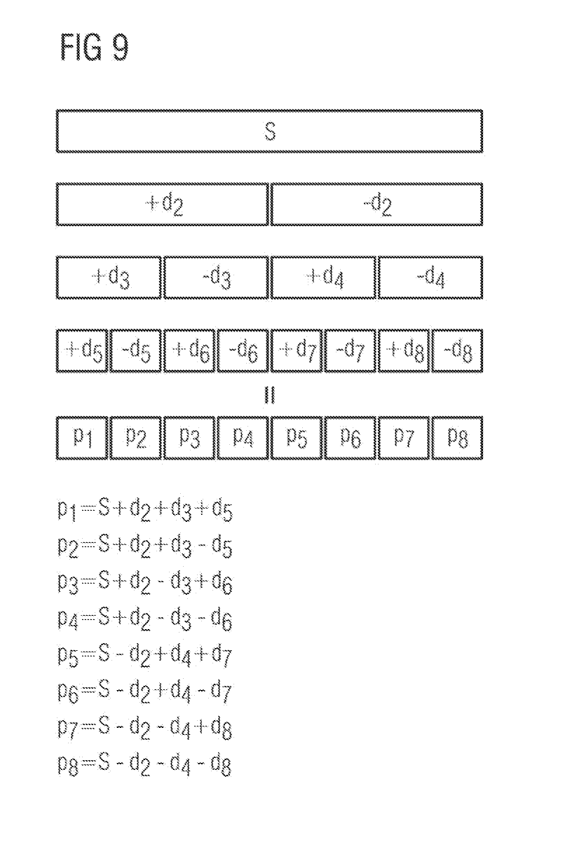

FIG. 9 shows how the wavelet coefficients detected and calculated in a sound wave signal according to FIGS. 5-7 can be transformed back to a sound wave signal. Using an inverse transformation from the coefficients together with a sum S of all the absolute wave pressures, it is possible to calculate back to the absolute wave pressures at all the measurement time points per overall time interval I_{G}. Using a loudspeaker, the calculated absolute wave pressures can be converted back into a pressure wave signal. Therefore a pressure p₁=S+d₂+d₃+d₅. Furthermore, all the pressures p₂ . . . p₈ can be calculated again as illustrated in FIG. 9.

There are two routes of data flow:
The pressure differences are measured, digitized and stored. By means of inverse transformation using an upper Hessenberg matrix, the pressure values for the reproduction can be calculated again
The pressure difference values are measured and therefrom the wavelet coefficients are formed. These are digitized and stored. Using an inverse wavelet transformation, the pressure values can be calculated once more.

For half of all measured differences, pressure differences and wavelet coefficients are identical, specifically at the finest level.

Through skilled sorting of the values of the difference measurements, an upper Hessenberg matrix can be constructed for an inverse transformation. In this way, a particularly efficient inverse transformation is made possible. It should be made clear in this regard that the measured pressure differences are, in general, not wavelet coefficients. Wavelet coefficients can be calculated from the pressure differences. Once all the absolute wave pressures have been calculated, a pressure wave signal can be reproduced by means of a loudspeaker.

An example of an upper Hessenberg matrix for inverse transformation of pressure difference values into absolute pressure values is shown below:

$$[ \begin{matrix}1 & 1 & 1 & 1 & 1 & 1 & 1 & 1 \\ 1 & - 1 & 0 & 0 & 0 & 0 & 0 & 0 \\ 0 & 1 & 0 & - 1 & 0 & 0 & 0 & 0 \\ 0 & 0 & 1 & - 1 & 0 & 0 & 0 & 0 \\ 0 & 0 & 0 & 1 & 0 & 0 & 0 & - 1 \\ 0 & 0 & 0 & 0 & 1 & - 1 & 0 & 0 \\ 0 & 0 & 0 & 0 & 0 & 1 & 0 & - 1 \\ 0 & 0 & 0 & 0 & 0 & 0 & 1 & - 1\end{matrix} ] [ \begin{matrix}{p}_{1} \\ {p}_{2} \\ {p}_{3} \\ {p}_{4} \\ {p}_{5} \\ {p}_{6} \\ {p}_{7} \\ {p}_{8}\end{matrix} ] = [ \begin{matrix}S \\ {Dp}_{12} \\ {Dp}_{24} \\ {Dp}_{34} \\ {Dp}_{48} \\ {Dp}_{56} \\ {Dp}_{68} \\ {Dp}_{78}\end{matrix} ]$$

What is claimed is:

1. A method for recording a pressure wave signal, comprising detecting and storing directly quantified wave pressure differences of the pressure wave signal.

2. The method according to claim 1, wherein coefficients of a basis function containing information of the pressure wave signal are calculated on the basis of the detected and directly quantified wave pressure differences of the pressure wave signal and stored.

3. The method according to claim 2, wherein the basis function is a wavelet basis function.

4. The method according to claim 1, wherein respective different wave pressure differences from different measurement time intervals are detected in repeating overall time intervals by a variety of pressure-gradient microphones.

5. The method according to claim 4, wherein an overall interval is equally subdivided into a number of equal-length basic time intervals and the length of a basic time interval is determined by means of a highest and a lowest frequency to be resolved.

6. The method according to claim 5, wherein the highest frequency to be resolved is divided by the lowest frequency to be resolved and the quotient determines the number and length of the basic time intervals in an overall time interval.

7. The method according to claim 6, wherein the number of basic time intervals is expressed as a power of 2, that is 2^{m}, with the exponent m, which determines the number of pressure-gradient microphones used.

8. The method according to claim 4, wherein by means of a sound pressure microphone, absolute wave levels at all measurement time points of an overall time interval are added to form a sum S.

9. The method according to claim 8, wherein all the coefficients are calculated by means of the wave pressure differences detected and the sum S per overall time interval is calculated.

10. The method according to claim 3, wherein the wavelet basis function is
a Haar wavelet function,
a Coiflet wavelet function,
a Gabor wavelet function,
a Daubechies wavelet function,
a Johnston-Barnard wavelet function or
a bioorthogonal spline wavelet function.

11. The method according to claim 7, wherein the wavelet basis function is selected from the group consisting of a Haar wavelet function, a Coiflet wavelet function, a Gabor wavelet function, a Daubechies wavelet function, a Johnston-Barnard wavelet function and a bioorthogonal spline wavelet function, and
the wavelet basis function being a Haar wavelet basis function, characterized in that in each instance, one of m pressure-gradient microphones detects pressure differences from 2ⁿ basic time intervals as the measurement time interval, the measurement time intervals each being separated from one another by 2ⁿ basic time intervals, wherein n is the element N₀ and n≦m−1.

12. The method according to claim 2, wherein compression is carried out in that coefficients below a threshold value are ignored.

13. The method according to claim 4, wherein a plurality of different pressure-gradient microphones is used for different frequency ranges.

14. The method according to claim 13, wherein the areas of detection diaphragms of the pressure-gradient microphones are tuned to the respective frequency range.

15. The method according to claim 13, wherein the detection diaphragms of the pressure-gradient microphones are arranged adjacent to one another in one housing.

16. The method according to claim 15, wherein the detection diaphragms are arranged concentrically with one another.

17. The method according to claim 16, wherein detection diaphragms for higher frequency wave pressure differences are arranged inwardly and detection diaphragms for lower frequency wave pressure differences are arranged outwardly.

18. A method for reproducing a pressure wave signal recorded with a method according to claim 1, wherein, by means of an upper Hessenberg matrix, the absolute wave pressures are calculated back from the stored pressure differences at all the measurement time points per overall time interval, and are output.

19. The method for reproducing a pressure wave signal recorded with a method according to claim 2, wherein, by means of an inverse transformation from the coefficients, optionally together with the sum S, the absolute wave pressures are calculated in reverse and reproduced for all the measurement time points per overall time interval.

20. Pressure-gradient microphones for recording a pressure wave signal with detecting and storing directly quantified wave pressure differences of the pressure wave signal, wherein areas of detection diaphragms of the pressure-gradient microphones are tuned to the respective frequency range.

21. The pressure-gradient microphones according to claim 20, wherein the detection diaphragms of the pressure-gradient microphones are arranged adjacent to one another in one housing.

22. The pressure-gradient microphones according to claim 21, wherein the detection diaphragms are arranged concentrically with one another.

23. The pressure-gradient microphones according to claim 22, wherein detection diaphragms for higher frequency wave pressure differences are arranged inwardly and detection diaphragms for lower frequency wave pressure differences are arranged outwardly.

24. A method comprising using of a microphone according to claim 20 for sound pressure waves in the audio range or the ultrasonic range in medicine or materials science or for seismic waves in geophysics or materials science.
